(19) United States
(12) Patent Application Publication
(10) Pub. No.: US 2015/0142784 A1
(43) Pub. Date: May 21, 2015

(54) RETRIEVAL DEVICE AND METHOD AND COMPUTER PROGRAM PRODUCT

(71) Applicant: Kabushiki Kaisha Toshiba, Tokyo (JP)

(72) Inventors: Tomoyuki SHIBATA, Kawasaki Kanagawa (JP); Yuto YAMAJI, Kawasaki Kanagawa (JP); Isao MIHARA, Shinagawa Tokyo (JP)

(21) Appl. No.: 14/543,427

(22) Filed: Nov. 17, 2014

(30) Foreign Application Priority Data
Nov. 20, 2013 (JP) 2013-240279

(51) Int. Cl. G06F 17/30; G06K 9/00

(52) U.S. Cl. CPC G06F 17/30684; G06K 9/00416; G06K 9/00422
USPC 707/722

(57) ABSTRACT

According to an embodiment, a retrieval device includes an obtaining controller, a retrieving controller, and a display controller. The obtaining controller obtains handwritten data indicative of a position of a component part of a targeted piece of content. The retrieving controller retrieves, based on the handwritten data, the targeted piece of content from a memory which stores therein one or more pieces of content. The display controller displays a search result on a display.

### CROSS-REFERENCE TO RELATED APPLICATIONS

This application is based upon and claims the benefit of priority from Japanese Patent Application No. 2013-240279, filed on Nov. 20, 2013; the entire content of which are incorporated herein by reference.

### FIELD

Embodiments described herein relate generally to a retrieval device, a retrieval method, and a computer program product.

### BACKGROUND

Conventionally, a technology is known for retrieving documents based on a handwritten query input by a user.

However, in a conventional technology as mentioned above, it is nothing more than replacing the handwritten data, which has been input, with characters by performing character recognition and retrieving pieces of content having the characters which are identical or similar to the characters substituted for the handwritten data.

For that reason, in such a conventional technology, it is not possible to retrieve a targeted piece of content by specifying the positions of the component parts of the targeted piece of content.

### BRIEF DESCRIPTION OF THE DRAWINGS

FIG. 1 is a configuration diagram illustrating an example of a retrieval device according to an embodiment;

FIG. 2 is a diagram illustrating an example of a targeted piece of content according to the embodiment;

FIG. 3 is a diagram illustrating an example of handwritten data according to the embodiment;

FIG. 4 is a diagram illustrating an example of a search result according to the embodiment;

FIG. 5 is a diagram illustrating an example of a targeted piece of content according to the embodiment;

FIG. 6 is a diagram illustrating an example of the handwritten data according to the embodiment;

FIG. 7 is a diagram illustrating an example of the handwritten data according to the embodiment;

FIG. 8 is a diagram illustrating an example of the handwritten data according to the embodiment;

FIG. 9 is a diagram illustrating an example of the handwritten data according to the embodiment;

FIG. 10 is a diagram illustrating an example of the handwritten data according to the embodiment;

FIG. 11 is a flowchart for explaining an exemplary sequence of operations during a retrieval operation performed in the retrieval device according to the embodiment;

FIG. 12 is a diagram illustrating an example of a targeted piece of content according to a modification example;

FIG. 13 is a diagram illustrating an example of the handwriting data according to the modification example; and

FIG. 14 is a diagram illustrating an exemplary hardware configuration of the retrieval device according to the embodiment and the modification examples.

### DETAILED DESCRIPTION

According to an embodiment, a retrieval device includes an obtaining controller, a retrieving controller, and a display controller. The obtaining controller obtains handwritten data indicative of a position of a component part of a targeted piece of content. The retrieving controller retrieves, based on the handwritten data, the targeted piece of content from a memory which stores therein one or more pieces of content. The display controller displays a search result on a display.

An embodiment is described below in detail with reference to the accompanying drawings.

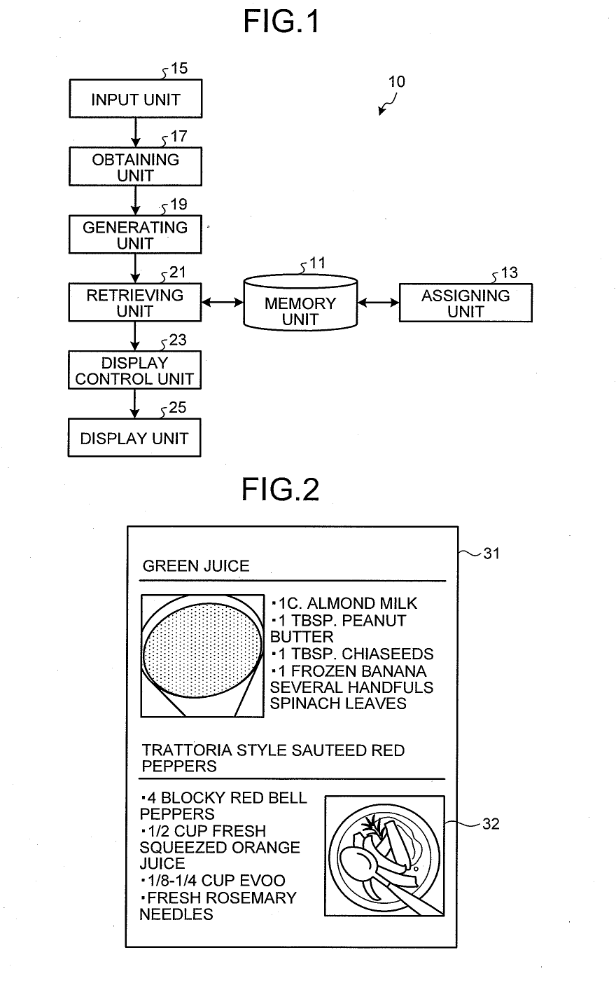

FIG. 1 is a configuration diagram illustrating an example of a retrieval device 10 according to the embodiment. As illustrated in FIG. 1, the retrieval device 10 includes a memory unit 11, an assigning unit 13, an input unit 15, an obtaining unit 17, a generating unit 19, a retrieving unit 21, a display control unit 23, and a display unit 25.

The memory unit 11 can be implemented using a memory device such as a hard disk drive (HDD), a solid state drive (SSD), a memory card, an optical disk, a read only memory (ROM), or a random access memory (RAM) in which information can be stored in a magnetic, optical, or electrical manner. The assigning unit 13, the obtaining unit 17, the generating unit 19, the retrieving unit 21, and the display control unit 23 can be implemented by executing computer programs in a processing device such as a central processing unit (CPU), that is, can be implemented using software; or can be implemented using hardware such as an integrated circuit (IC); or can be implemented using a combination of software and hardware. The input unit 15 can be implemented using an input device such as a touch-sensitive panel, a touch pad, a mouse, or an electronic pen that enables handwritten input. The display unit 25 can be implemented using a display device such as a touch-sensitive panel display or a liquid crystal display.

The memory unit 11 is used to store one or more pieces of content. In the embodiment, a piece of content is assumed to be one of the following: a document created using document preparation software, spreadsheet software, presentation software, or document browsing software; a digital document such as a Web page; and a handwritten document prepared by a user by inputting handwritten data. However, that is not the only possible case. Alternatively, a piece of content can be made of still images or moving images.

The assigning unit 13 analyzes each piece of content stored in the memory unit 11; generates structural information which indicates the position of each of a plurality of component parts of that piece of content, the relative positional relationship among those component parts, and the type of each component part; and assigns the structural information to that piece of content.

Herein, a component part of a piece of content represents an area that is recognizable by the user. The position of a component part can be in the form of, for example, coordinate information on a page. The relative positional relationship between two component parts can be identified from the positions (the coordinate information) of those two component parts.

The type of a component part can be, for example, at least either one of “characters”, “graphic form”, “table”, “image”, and “picture”. If a component part is of the type “characters”, then that type can be further subdivided into paragraphs, lines, words, single characters, and radicals. Moreover, if a component part is of the type “graphic form”, then that type can be further subdivided into straight lines, triangles, quadrilaterals, and circles. Furthermore, if a component part is of the type “image”, then that type can be further subdivided into objects and edges captured in the image. In order to recognize an object captured in an image, it is possible to implement the object recognition technique disclosed in Jim Mutch and David G. Lowe. Multiclass Object Recognition with Sparse, Localized Features. IEEE Conference on Computer Vision and Pattern Recognition (CVPR), pp. 11-18, New York, June 2006. An edge in an image represents a line that undergoes a change in the luminance value or the color in a recognizable manner. Meanwhile, for example, it is also possible to have “color”, such as the red color, the blue color, and the green color, as a type of a component part. Moreover, for example, it is also possible to have “density”, such as concentrated and dilute, as a type of a component part.

When a piece of content represents a digital document, then the document information contains the positions of the component parts, the relative positional relationship among the component parts, and information enabling identification of the types of the component parts. Thus, the assigning unit 13 can generate structural information by analyzing that piece of content.

In the case in which a piece of content represents a handwritten document, it is possible to perform analysis of the class to which each stroke constituting the handwritten data belongs and the position of that stroke; and to identify the positions of the component parts, the relative positional relationship among the component parts, and the types of the component parts. Herein, a class can be, for example, at least one of “characters”, “graphic form”, “table”, “image”, and “picture”. Thus, also in the case in which a piece of content represents handwritten data, the assigning unit 13 can generate structural information by analyzing that piece of content.

Meanwhile, in order to determine the classes to which the strokes belongs, the following techniques can be implemented: a technique in which a set of strokes is subjected to structuring in terms of spatial or temporal cohesiveness, and, at each structural unit obtained as a result of structuring, the class to which the strokes attributed to that structural unit belong is determined; or a technique in which, for each stroke, one or more neighboring strokes present around that stroke are extracted, a combinational feature quantity is calculated that is related to the feature quantity of the combination of the concerned stroke and the one or more neighboring strokes that are extracted, and the class to which the concerned stroke belongs is determined according to the combinational feature quantity.

The combinational feature quantity includes a first-type feature quantity that indicates the relationship between the concerned stroke and at least one of the one or more neighboring strokes. Moreover, the combinational feature quantity includes a second-type feature quantity obtained using the sum value of the feature quantity related to the shape of the concerned stroke and the feature quantity related to the shape of each of the one or more neighboring strokes.

The first-type feature quantity is at least one of the following two: the degree of shape similarity between the concerned stroke and at least one of the one or more neighboring strokes; and a specific value that enables identification of the positional relationship between the concerned stroke and at least one of the one or more neighboring strokes.

Herein, the degree of shape similarity between the concerned stroke and at least one of the one or more neighboring strokes indicates, for example, the degree of similarity in at least one of the lengths, the curvature sums, the main-component directions, the bounding rectangle areas, the bounding rectangle lengths, the bounding rectangle aspect ratios, the start point/end point distances, the direction density histograms, and the number of folding points. Thus, for example, the degree pf shape similarity can be regarded as the degree of similarity between a stroke feature quantity of the concerned stroke and a stroke feature quantity of at least one of the one or more neighboring strokes.

The specific value is, for example, at least one of the overlapping percentage of bounding rectangles of the target stroke and at least one of the one or more neighboring strokes, the gravity point distance between those two strokes, the direction of the gravity point distance between those two strokes, the end point distance between those two strokes, the direction of the end point distance between those two strokes, and the number of points of intersection between those two strokes.

The second-type feature quantity is, for example, at least one of the following:the ratio of the sum of the length of the concerned stroke with respect to the bounding rectangle length of the combination and the length of each of the one or more neighboring strokes with respect to the bounding rectangle length of the combination; the sum value of the direction density histograms of the concerned stroke and at least one of the one or more neighboring strokes; and the ratio of the sum of the bounding rectangle area of the concerned stroke and the bounding rectangle area of each of the one or more neighboring strokes with respect to the bounding rectangle area of the combination.

The input unit 15 receives input of handwritten data which specifies the positions of the component parts of the targeted piece of content. More specifically, in addition to specifying the position of each of a plurality of component parts of the targeted piece of content, the handwritten data also specifies the relative positional relationship among the component parts. Moreover, the handwritten data can further specify the type of each of a plurality of component parts. Meanwhile, the handwritten data is made of a plurality of strokes.

In the embodiment, it is assumed that a plurality of component parts of the targeted piece of content is present on the same page and that the position of each of a plurality of component parts is a position on that same page. However, that is not the only possible case.

In the embodiment, it is assumed that the input unit 15 is a touch-sensitive panel, and that the user inputs handwritten data by writing at least one of graphic forms, pictures, and characters by hand on the touch-sensitive panel using a stylus pen or a finger. However, that is not the only possible case. Alternatively, for example, the input unit 15 can be implemented using a touch-pad, a mouse, or an electronic pen.

A stroke points to a stroke of a graphic form, a picture, or a character written by hand by the user, and represents data of the locus from the time when a stylus pen or a finger makes contact with the input screen of the touch-sensitive panel until it is lifted from the input screen (i.e., the locus from a pen-down action to a pen-up action). For example, a stroke can be expressed as time-series coordinate values of contact points between a stylus pen or a finger and the input screen.

The obtaining unit 17 obtains the handwritten data which is input from the input unit 15.

The generating unit 19 generates a search query by formatting the handwritten data obtained by the obtaining unit 17. More specifically, the generating unit 19 generates a search query by performing character recognition, graphic recognition, table recognition, and image recognition with respect to the handwritten data obtained by the obtaining unit 17.

The retrieving unit 21 retrieves the targeted piece of content from the memory unit 11 based on the handwritten data obtained by the obtaining unit 17. In the embodiment, the retrieving unit 21 refers to the structural information of each of one or more pieces of content stored in the memory unit 11, and retrieves the targeted piece of content.

More particularly, the retrieving unit 21 compares the search query generated by the generating unit 19 with the structural information of each of one or more pieces of content that are stored in the memory unit 11, and retrieves the targeted piece of content. For example, of one or more pieces of content stored in the memory unit 11, the retrieving unit 21 retrieves, as the targeted piece of content, such pieces of content for which the degree of structural information similarity with the search query exceeds a threshold value. Herein, the degree of structural information similarity can be set to be, for example, the rate of concordance of the range among concordant component parts.

Meanwhile, each of one or more pieces of content stored in the memory unit 11 is configured to be able to derive the position of each of a plurality of corresponding component parts, the relative positional relationship among those component parts, and the type of each component part. Hence, the retrieving unit 21 analyzes each piece of content stored in the memory unit 11; derives the position of each of a plurality of component parts of that piece of content, the relative positional relationship among those component parts, and the type of each of those component parts; compares the search query generated by the generating unit 19 with the derived information; and retrieves the targeted piece of content. In this way, even if the assigning unit 13 does not assign the structural information to the pieces of content, it becomes possible to retrieve the targeted piece of content.

The display control unit 23 displays the search result of the retrieving unit 21 on the display unit 25.

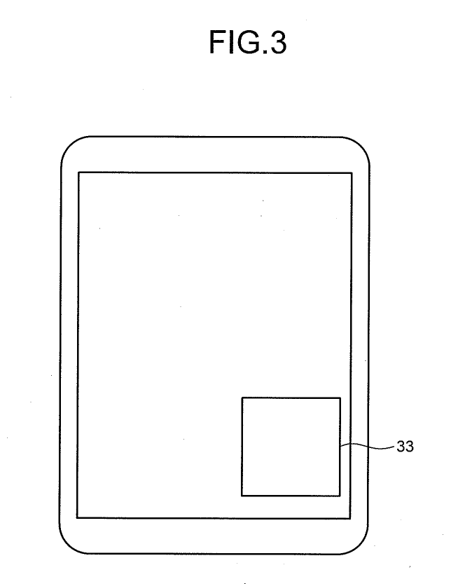

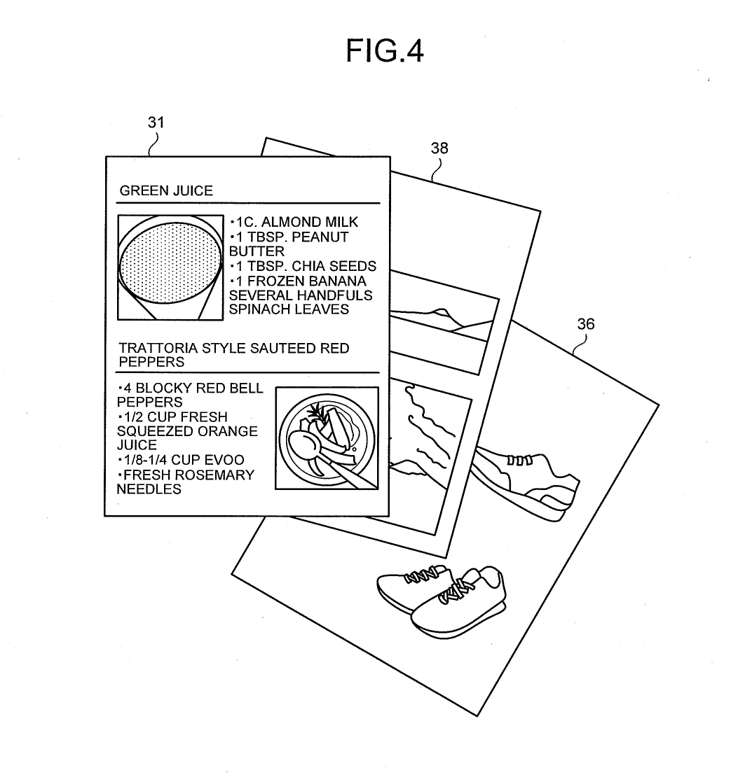

Explained below with reference to FIG. 2 to FIG. 4 is an exemplary search performed according to the embodiment. FIG. 2 is a diagram illustrating a targeted piece of content 31 according to the embodiment. FIG. 3 is a diagram illustrating an example of handwritten data according to the embodiment. FIG. 4 is a diagram illustrating an example of the search result according to the embodiment.

As illustrated in FIG. 2, it is assumed that, in the targeted piece of content 31, an area 32 for images (photographs) is provided on the lower right-hand portion. In this case, as illustrated in FIG. 3, the input unit 15 of the retrieval device 10 receives input of handwritten data that specifies an area 33, which is of the type “image” and which is located on the lower right-hand portion of the page. Then, the generating unit 19 generates a search query by formatting the handwritten data which has been input. Subsequently, the retrieving unit 21 compares the generated search query with the structural information of each of one or more pieces of content stored in the memory unit 11, and retrieves such pieces of content for which the degree of structural information similarity with the search query exceeds a threshold value. That is, the retrieving unit 21 retrieves such pieces of content in which the area for images is located at the lower right-hand portion of the page. As a result, as illustrated in FIG. 4, the search results obtained by the retrieving unit 21 include the targeted piece of content 31, a piece of content 36, and a piece of content 38. Hence, it becomes possible to retrieve the targeted piece of content 31.

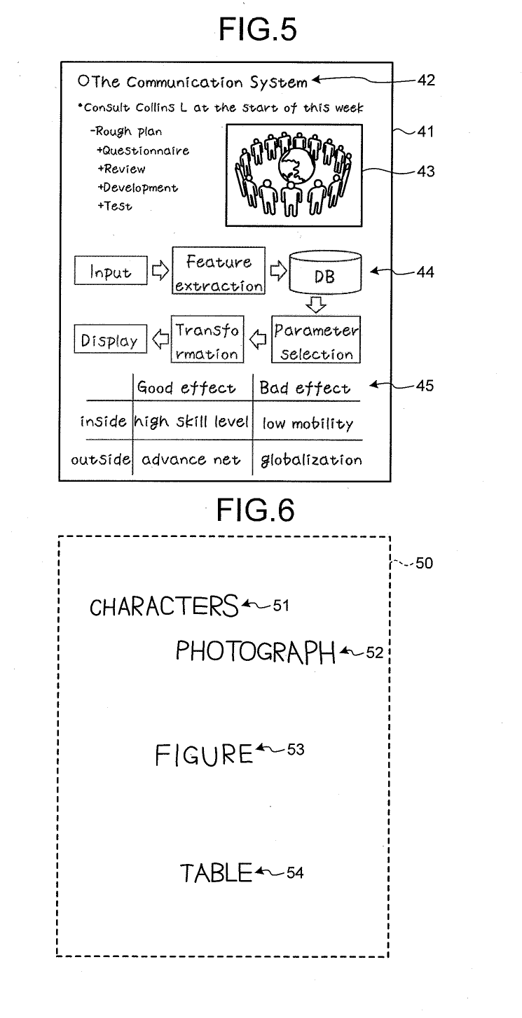

Explained below with reference to FIGS. 5 to 10 are specific examples of the handwritten data (the search query) according to the embodiment. FIG. 5 is a diagram illustrating an example of a targeted piece of content 41 according to the embodiment. FIGS. 6 to 10 are diagrams illustrating examples of the handwritten data according to the embodiment.

As illustrated in FIG. 5, on the left-hand side at the upper level of the targeted piece of content 41, an area 42 for characters is provided. On the right-hand side at the upper level of the targeted piece of content 41, an area 43 for images (photographs) is provided. At the middle level of the targeted piece of content 41, an area for graphic forms is provided. At the lower level of the targeted piece of content 41, an area 45 for tables is provided.

In this case, as the handwritten data for the purpose of searching for the targeted piece of content 41; it is possible to think of, for example, pieces of handwritten data illustrated in FIGS. 6 to 10.

In the handwritten data illustrated in FIG. 6, handwritten characters are written at the position of each of a plurality of component parts of the targeted piece of content. Thus, the following is specified with the handwritten characters: the position of each of a plurality of component parts of the targeted piece of content, the relative positional relationship among the component parts, and the type of each component part.

More particularly, in the handwritten data illustrated in FIG. 6, a term “characters” 51 is written by hand in the upper left-hand portion of a page 50. As a result, it gets specified that a character area is present in the upper left-hand portion. Moreover, a term “photograph” 52 is written by hand in the upper right-hand portion of the page 50. As a result, it gets specified that a photograph area is present in the upper right-hand portion. Furthermore, a term “figure” 53 is written by hand in the middle portion of the page 50. As a result, it gets specified that a graphic area is present in the middle portion. Moreover, a term “table” 54 is written by hand in the lower portion of the page 50. As a result, it gets specified that a table area is present in the lower portion.

Thus, using the handwritten data illustrated in FIG. 6, it is possible to easily specify the position of each of a plurality of component parts of the targeted piece of content, the relative positional relationship among the component parts, and the type of each component part. Hence, it becomes easy to perform an input operation. Besides, it becomes possible to also deal with a case in which the user has only a vague memory of the configuration of the targeted piece of content 41. However, in the handwritten data illustrated in FIG. 6, since the types of component parts are identified with handwritten characters, the generating unit 19 needs to perform character recognition with respect to the handwritten characters at the time of generating a search query. Meanwhile, in the example illustrated in FIG. 6, at the position of each of a plurality of component parts of the targeted piece of content, characters are written by hand. However, alternatively, it is also possible to make use of icons or stamps that indicate the types of the component parts.

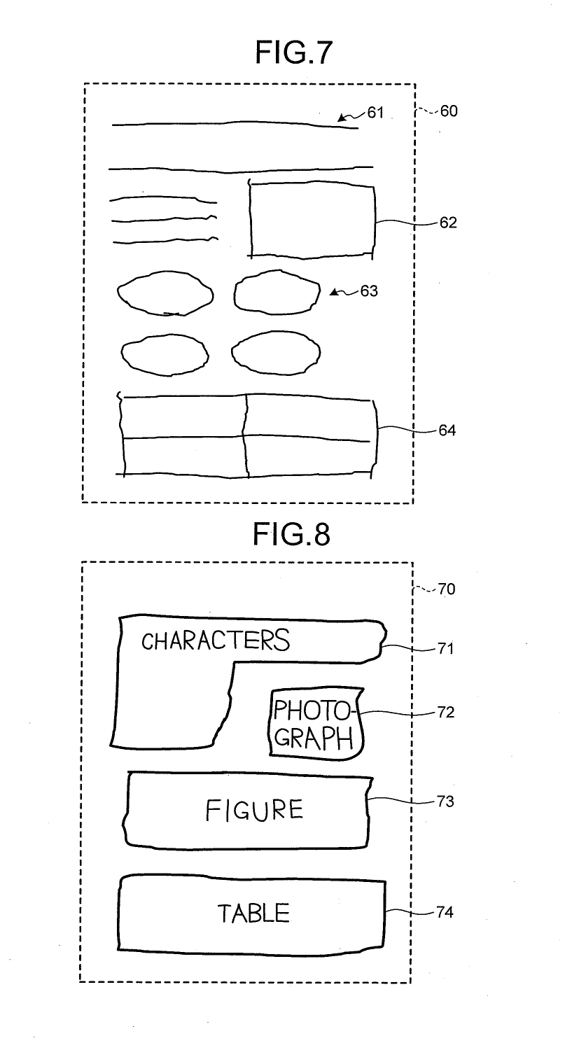

In the handwritten data illustrated in FIG. 7, in order to specify the position of each of a plurality of component parts of the targeted piece of content, the relative positional relationship among the component parts, and the type of each component part; handwritten signs (graphic forms) are written at the position of each of a plurality of component parts of the targeted piece of content.

More particularly, in the handwritten data illustrated in FIG. 7, horizontal lines 61 that are written by hand in the upper left-hand portion of a page 60 represent a sign that conceptualizes characters. As a result, it gets specified that a character area is present in the upper left-hand portion. Moreover, a rectangle 62 that is written by hand in the upper right-hand portion of the page 60 represents a sign that conceptualizes a photograph (image). As a result, it gets specified that a photograph area is present in the upper right-hand portion. Furthermore, ellipses 63 that are written by hand in the middle portion of the page 60 represent a sign that conceptualizes graphic forms. As a result, it gets specified that a graphic area is present in the middle portion. Moreover, a four-square design 64 that is written by hand in the lower portion of the page 60 represents a sign that conceptualizes a table. As a result, it gets specified that a table area is present in the lower portion. Meanwhile, the number of horizontal lines in the horizontal lines 61 may or may not match the number of lines in the character area.

Thus, using the handwritten data illustrated in FIG. 7 too, it is possible to easily specify the position of each of a plurality of component parts of the targeted piece of content, the relative positional relationship among the component parts, and the type of each component part. Hence, it becomes easy to perform an input operation. Besides, it becomes possible to also deal with a case in which the user has only a vague memory of the configuration of the targeted piece of content 41. Meanwhile, in the example illustrated in FIG. 7, horizontal lines are used as a sign that conceptualizes characters, a rectangle is used as a sign conceptualizing a photograph (image), ellipses are used as a sign that conceptualizes graphic forms, and a tabular design is used as a sign conceptualizing a table. However, alternatively, it is also possible to increase or change the conceptualization signs by means of additional learning.

In the handwritten data illustrated in FIG. 8, in order to specify the position of each of a plurality of component parts of the targeted piece of content, the relative positional relationship among the component parts, and the type of each component part; a handwritten circular shape or a handwritten polygonal shape is drawn at the position of each component part of the targeted piece of content, or handwritten characters are written within the handwritten circular shapes or the handwritten polygonal shapes.

More specifically, in the handwritten data illustrated in FIG. 8, a polygonal shape 71 having “characters” written therein is drawn by hand in the upper left-hand portion of a page 70. As a result, it gets specified that a character area is present in the upper left-hand portion. Moreover, a polygonal shape 72 having “photograph” written therein is drawn by hand in the upper right-hand portion of the page 70. As a result, it gets specified that a photograph area is present in the upper right-hand portion. Furthermore, a polygonal shape 73 having “figure” written therein is drawn by hand in the middle portion of the page 70. As a result, it gets specified that a graphic area is present in the middle portion. Moreover, a polygonal shape 74 having “table” written therein is drawn by hand in the lower portion of the page 70. As a result, it gets specified that a table area is present in the lower portion.

Thus, using the handwritten data illustrated in FIG. 8, it is possible to concretely specify the position of each of a plurality of component parts of the targeted piece of content, the relative positional relationship among the component parts, and the type of each component part can be specified in the concrete. Hence, it becomes easy to perform a retrieval operation. However, in the handwritten data illustrated in FIG. 8, since the types of component parts are identified with handwritten characters, the generating unit 19 needs to perform character recognition with respect to the handwritten characters at the time of generating a search query.

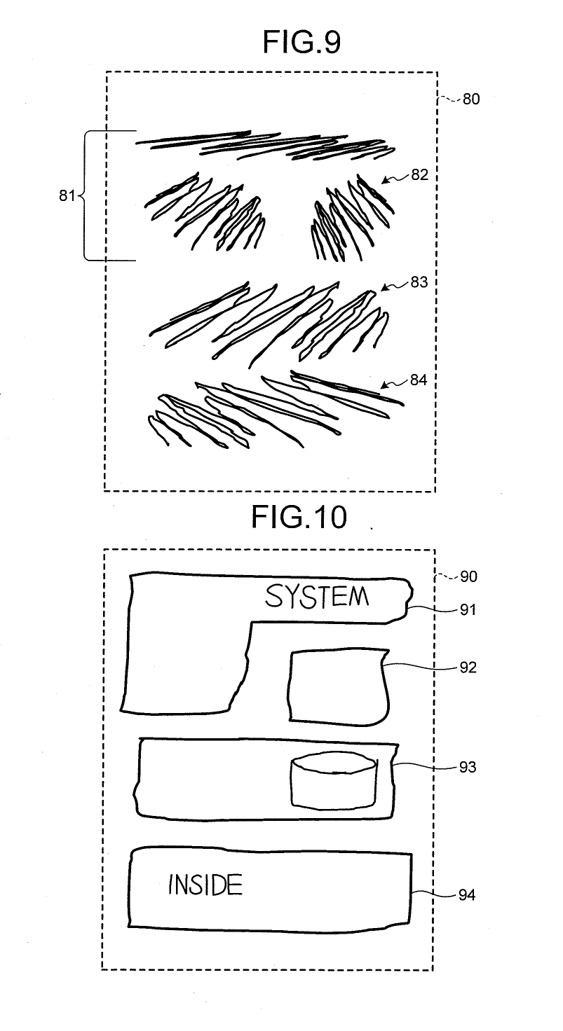

In the handwritten data illustrated in FIG. 9, in order to specify the position of each of a plurality of component parts of the targeted piece of content, the relative positional relationship among the component parts, and the type of each component part; a handwritten stroke is filled with a color at the position of each component part of the targeted piece of content.

More particularly, in the handwritten data illustrated in FIG. 9, the upper left-hand portion of a page 80 is filled with a stroke 81 having a color that represents characters. As a result, it gets specified that a character area is present in the upper left-hand portion. Moreover, the upper right-hand portion of the page 80 is filled with a stroke 82 having a color that represents a photograph (an image). As a result, it gets specified that a photograph area is present in the upper right-hand portion. Furthermore, the middle portion of the page 80 is filled with a stroke 83 having a color that represents graphic forms. As a result, it gets specified that a graphic area is present in the middle portion. Moreover, the lower portion of the page 80 is filled with a stroke 84 having a color that represents a table. As a result, it gets specified that a table area is present in the lower portion.

In the handwritten data illustrated in FIG. 9, it is possible to easily specify the position of each of a plurality of component parts of the targeted piece of content, the relative positional relationship among the component parts, and the type of each component part. Hence, it becomes easy to perform an input operation. Besides, it becomes possible to also deal with a case in which the user has only a vague memory of the configuration of the targeted piece of content 41. Meanwhile, the thickness of the stroke can be increased to simplify the task of color filling. Moreover, the density of color filling may or may not match the targeted piece of content 41.

In the handwritten data illustrated in FIG. 10, in order to specify the position of each of a plurality of component parts of the targeted piece of content and the relative positional relationship among the component parts, a handwritten circular shape or a handwritten polygonal shape is written at the position of each of a plurality of component parts of the targeted piece of content. In addition to that, in order to specify at least one of targeted characters and a targeted graphic form, at least one of handwritten characters and a handwritten graphic form is written in the handwritten circular shape or the handwritten polygonal shape.

In this case, of one or more pieces of content stored in the memory unit 11, the retrieving unit 21 retrieves, as the targeted piece of content, such pieces, of content for which the degree of structural information similarity with the search query exceeds a threshold value and in which at least one of handwritten characters and a handwritten graphic form is present at the position specified by a handwritten circular shape or a handwritten polygonal shape having at least one of handwritten characters and a handwritten graphic form written therein.

More particularly, in the handwritten data illustrated in FIG. 10, a polygonal shape 91 is written by hand in the upper left-hand portion of a page 90. As a result, it gets specified that an area is present in the upper left-hand portion. Moreover, a polygonal shape 92 is written by hand in the upper right-hand portion of the page 90. As a result, it gets specified that an area is present in the upper right-hand portion. Furthermore, a polygonal shape 93 is written by hand in the middle portion of the page 90. As a result, it gets specified that an area is present in the middle portion. Moreover, a polygonal shape 94 is written by hand in the lower portion of the page 90. As a result, it gets specified that an area is present in the lower portion.

In addition to that, “System” is written by hand in the polygonal shape 91. As a result, it gets specified that a keyword “System” is present in the area in the upper left-hand portion. Similarly, a cylinder is drawn by hand in the polygonal shape 93. As a result, it gets specified that a cylinder is present in the area in the middle portion. Moreover, “inside” is written by hand in the polygonal shape 94. As a result, it gets specified that a keyword “inside” is present in the area in the lower portion.

Thus, in the handwritten data illustrated in FIG. 10, in addition to specifying the position of each of a plurality of component parts of the targeted piece of content and the relative positional relationship among the component parts; the conventional keyword search is also performed in combination. For that reason, as compared to the conventional keyword search, it becomes possible to narrow down the search results. However, in the handwritten data illustrated in FIG. 10, since the types of component parts are identified with handwritten characters, the generating unit 19 needs to perform character recognition with respect to the handwritten characters at the time of generating a search query.

Meanwhile, in the examples illustrated in FIGS. 6 to 10, since the handwritten data can be input in an interactive manner, the details explained with reference to FIGS. 6 to 10 need not be input at once. Rather, the input can be performed in a phased manner while checking the search results.

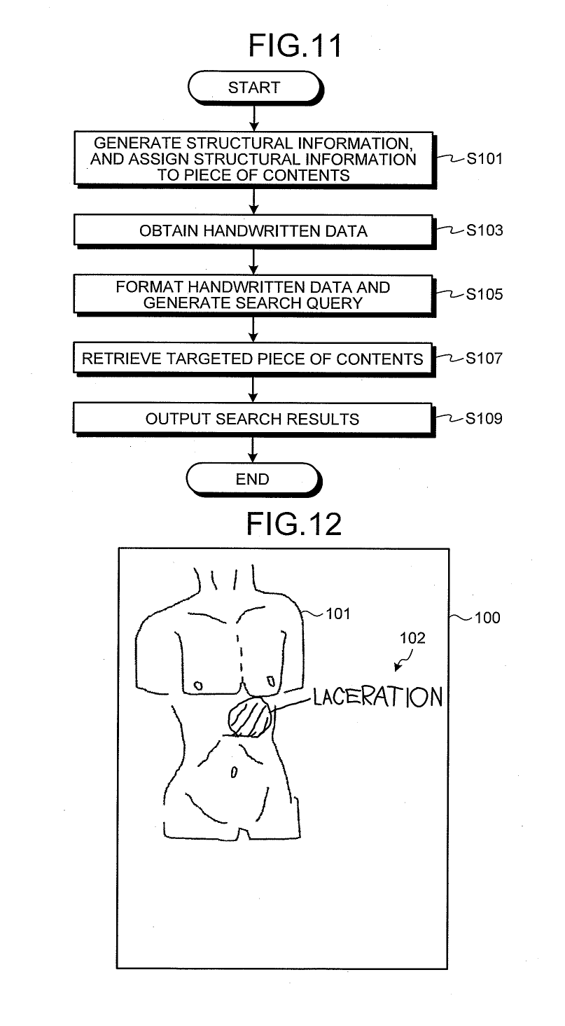

FIG. 11 is a flowchart for explaining an exemplary sequence of operations during a retrieval operation performed in the retrieval device 10 according to the embodiment.

Firstly, the assigning unit 13 analyzes each piece of content stored in the memory unit 11; generates structural information which indicates the position of each of a plurality of component parts of that piece of content, the relative positional relationship among those component parts, and the type of each component part; and assigns the structural information to that piece of content (Step S101).

Then, the obtaining unit 17 obtains the handwritten data that is input from the input unit 15 (Step S103); and the display control unit 23 displays the obtained handwritten data on the display unit 25.

Subsequently, the generating unit 19 formats the handwritten data obtained by the obtaining unit 17 and generates a search query (Step S105).

Then, the retrieving unit 21 compares the search query, which is generated by the generating unit 19, with the structural information of each of one or more pieces of content stored in the memory unit 11; and retrieves the targeted piece of content (Step S107).

Then, the display control unit 23 displays the search results of the retrieving unit 21 on the display unit 25 (Step S109).

Herein, it is not necessary to perform the operations from Step S101 to Step S109 in succession. Alternatively, the operation at Step S101 can be performed once in advance. Moreover, the display of the handwritten display and the display of the search results can be performed at the same time. Furthermore, the timing at which the obtaining unit 17 finishes obtaining the handwriting data, that is, the timing at which the pen-up action is performed can be used as the trigger for starting the operations from Step S105 onward.

In this way, according to the embodiment, by specifying the positions of the component parts of the targeted piece of content, it becomes possible to retrieve the targeted piece of content. Particularly, in the embodiment, it is only necessary to specify the positions of the component parts of the targeted piece of content. With that, even in a case in which the user has only a vague memory of the configuration of the targeted piece of content, it becomes possible to retrieve the targeted piece of content.

### First Modification Example

In the embodiment described above, it is also possible to treat an electronic health record as the targeted piece of content.

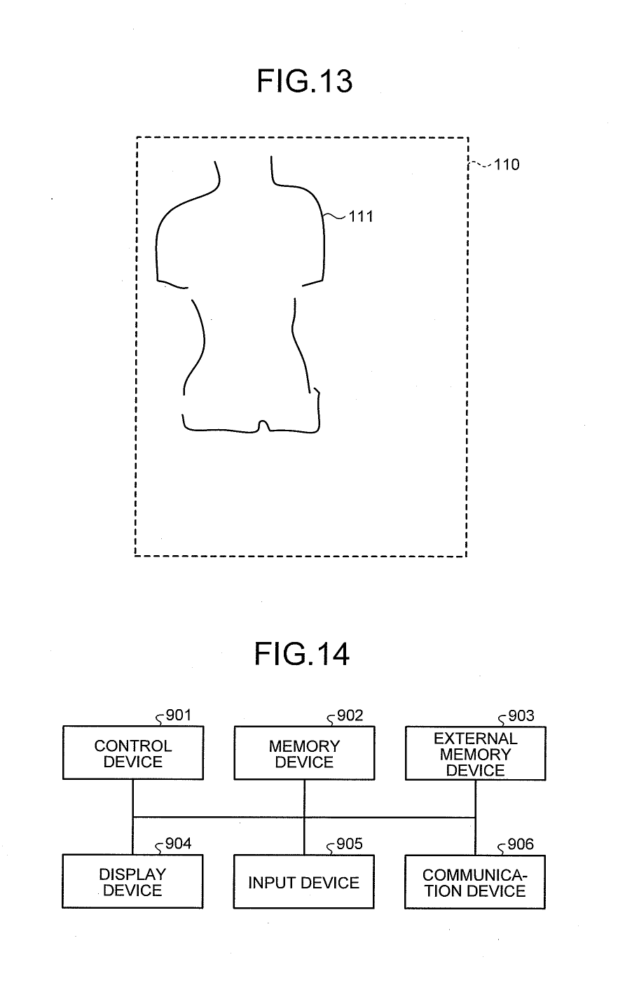

FIG. 12 is a diagram illustrating an example of a targeted piece of content 100 according to a first modification example. FIG. 13 is a diagram illustrating an example of the handwriting data according to the first modification example.

As illustrated in FIG. 12, an area 101 for a schema is provided in the upper left-hand portion of the targeted piece of content 100. Moreover, at the central portion of the schema, a picture area is provided for indicating the affected part and a character area 102 is provided for writing a comment regarding the affected part. Herein, the schema is a template of a diagram of a human body, and has the location of the affected part and the comment regarding the affected part written therein.

In this case, as the handwritten data to be used in searching for the targeted piece of content 100, it is possible to think of, for example, the handwritten data illustrated in FIG. 13.

In the handwritten data illustrated in FIG. 13, the positions and the types of the component parts of the targeted piece of content are specified by a handwritten picture (a rough sketch) drawn at the positions of the component parts of the targeted content.

More particularly, in the handwritten data illustrated in FIG. 13, a rough sketch 111 of the schema is drawn by hand in the upper left-hand portion of a page 110. As a result, it gets specified that a schema area is present in the upper left-hand portion.

In the case of the first modification example, the assigning unit 13 generates structural information that further contains schema information; and then assigns the structural information to the pieces of content. Herein, the schema information contains the position of the schema area and the type of schema template.

The retrieving unit 21 can be configured to further retrieve a schema that matches with the shape of the rough sketch of the handwritten data. In this case, as far as the matching method for line drawings is concerned, it is possible to use the technology called chamfer matching in which images are generated in such a way that, closer a pixel from the lines of the line drawings, greater is the pixel value of that pixel; and the distance between line drawings is obtained according to Euclidean distance between the generated images. Then, using the obtained distance, the retrieving unit 21 can retrieve the template of a schema that is closest to the line drawings which have been drawn.

### Second Modification Example

In the embodiment described above, the explanation is given about an example in which all component parts are included in the retrieval device 10. However, that is not the only possible case. Alternatively, for example, some of the component parts can be present outside the retrieval device 10. For example, some of the component parts can be present on the cloud.

Hardware Configuration

FIG. 14 is a diagram illustrating an exemplary hardware configuration of the retrieval device 10 according to the embodiment and the modification examples described above. The retrieval device 10 according to the embodiment and the modification examples described above has the hardware configuration of a commonplace computer that includes a control device 901 such as a central processing unit (CPU), a memory device 902 such as a read only memory (ROM) or a random access memory (RAM), an external memory device 903 such as a hard disk drive (HDD), a display device 904 such as a display, an input device 905 such as a keyboard or a mouse, and a communication device 906 such as a communication interface.

Meanwhile, computer programs executed in the retrieval device 10 according to the embodiment and the modification examples described above are recorded in the form of installable or executable files in a computer-readable recording medium such as a compact disk read only memory (CD-ROM), a compact disk readable (CD-R), a memory card, a digital versatile disk (DVD), or a flexible disk (FD).

Alternatively, the computer programs executed in the retrieval device 10 according to the embodiment and the modification examples described above can be saved as downloadable files on a computer connected to the Internet or can be made available for distribution through a network such as the Internet. Still alternatively, the computer programs executed in the retrieval device 10 according to the embodiment and the modification examples described above can be stored in advance in a ROM or the like.

The computer programs executed in the retrieval device 10 according to the embodiment and the modification examples described above contain modules for implementing each of the abovementioned constituent elements in a computer. In practice, for example, a CPU loads the computer programs from an HDD and runs them so that the computer programs are loaded in a RAM. As a result, the module for each constituent element is generated in the computer.

For example, unless contrary to the nature thereof, the steps of the flowchart according to the embodiment described above can have a different execution sequence, can be executed in plurality at the same time, or can be executed in a different sequence every time.

In this way, according to the embodiment and the modification examples described above, a targeted piece of content can be retrieved by specifying the positions of the component parts.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A retrieval device comprising:
an obtaining controller configured to obtain handwritten data indicative of a position of a component part of a targeted piece of content;
a retrieving controller configured to retrieve, based on the handwritten data, the targeted piece of content from a memory which stores therein one or more pieces of content; and
a display controller configured to display a search result on a display.

2. The device according to claim 1, wherein, in addition to specifying a position of each of a plurality of component parts of the targeted piece of content, the handwritten data further specifies a relative positional relationship among the plurality of component parts.

3. The device according to claim 2, wherein the handwritten data further specifies a type of each of the plurality of component parts.

4. The device according to claim 3, wherein each of the one or more pieces of content is configured to be able to derive a position of each of the plurality of component parts of corresponding one of the one or more pieces of content, a relative positional relationship among the plurality of component parts, and a type of each of the plurality of component parts.

5. The device according to claim 4, further comprising an assigning controller configured to
analyze each of the one or more pieces of content,
generate structural information indicative of the position of each of the plurality of component parts, the relative positional relationship, and the type of each of the plurality of component parts, and
assign the structural information to each of the one or more pieces of content, wherein
the retrieving controller refers to the structural information of each of the one or more pieces of content, and retrieves the targeted pieces of content.

6. The device according to claim 5, further comprising a generating controller configured to format the handwritten data and generate a search query, wherein
the retrieving controller configured to compare the search query with the structural information of each of the one or more pieces of content, and retrieves the targeted piece of content.

7. The device according to claim 6, wherein, of the one or more pieces of content, the retrieving controller is configured to retrieve, as the targeted piece of content, a piece of content for which a degree of similarity of the structural information with the search query exceeds a threshold value.

8. The device according to claim 7, wherein the handwriting data specifies the position of each of the component parts of the targeted piece of content, specifies the relative positional relationship, and specifies the type of each of the component parts with handwritten characters written at the position of each of the plurality of component parts.

9. The device according to claim 7, wherein the handwriting data specifies the position of each of the component parts of the targeted piece of content, specifies the relative positional relationship, and specifies the type of each of the component parts with a handwritten sign written at the position of each of the plurality of component parts.

10. The device according to claim 7, wherein the handwriting data specifies the position of each of the component parts of the targeted piece of content, specifies the relative positional relationship, and specifies the type of each of the component parts with a handwritten circular shape or with a handwritten polygonal shape drawn at the position of each of the plurality of component parts or with handwritten characters written in the handwritten circular shape or the handwritten polygonal shape.

11. The device according to claim 7, wherein the handwriting data specifies the position of each of the component parts of the targeted piece of content, specifies the relative positional relationship, and specifies the type of each of the component parts with a handwritten stroke drawn at the position of each of the plurality of component parts and with a color of the handwritten stroke.

12. The device according to claim 7, wherein
the handwriting data specifies the position of each of the component parts of the targeted piece of content and specifies the relative positional relationship with a handwritten circular shape or a handwritten polygonal shape drawn at the position of each of the plurality of component parts, and specifies at least one of targeted characters and a targeted graphic form with at least one of handwritten characters and a handwritten graphic form written in the handwritten circular shape or the handwritten polygonal shape, and
of the one or more pieces of content, the retrieving controller is configured to retrieve, as the targeted piece of content, a piece of content for which a degree of similarity of the structural information with the search query exceeds a threshold value and in which at least one of the handwritten characters and the handwritten graphic form is present at the position specified with the handwritten circular shape or the handwritten polygonal shape having at least one of the handwritten characters and the handwritten graphic form written therein.

13. The device according to claim 3, wherein the type is at least one of characters, a graphic form, a table, an image, and a picture.

14. The device according to claim 7, wherein the handwritten data specifies the position of the component part of the targeted piece of content and specifies the type of the component part with a handwritten picture drawn at the position.

15. The device according to claim 2, wherein
the plurality of component parts of the targeted piece of content is present on a same page, and
the position of each of the plurality of component parts is on the same page.

16. A retrieval method by a retrieval device comprising:
obtaining handwritten data which specifies a position of a component part of a targeted piece of content;
retrieving, based on the handwritten data, the targeted piece of content from a memory which stores therein one or more pieces of content; and
displaying a search result on a display.

17. A computer program product comprising a non-transitory computer-readable medium containing a computer program that causes a computer to execute:
obtaining handwritten data which specifies a position of a component part of a targeted piece of content;
retrieving, based on the handwritten data, the targeted piece of content from a memory which stores therein one or more pieces of content; and
displaying a search result on a display.
